(19) United States
(12) Patent Application Publication
(10) Pub. No.: US 2019/0079285 A1
(43) Pub. Date: Mar. 14, 2019

(54) DISPLAY STRUCTURE WITH DIMMING MODULE AND BIASING DIMMING MODULE AND PARALLEL PLATE DIMMING MODULE THEREOF

(71) Applicant: JRF Photonics Tech. Co., Ltd., Tianjin City (CN)

(72) Inventors: Ching-Cherng SUN, Taoyuan (TW); Yu-Hsiang TENG, Taoyuan (TW); Yeh-Wei YU, Taoyuan (TW); Tsung-Hsun YANG, Taoyuan (TW); Ko-Ting CHENG, Taoyuan (TW)

(73) Assignee: JRF Photonics Tech. Co., Ltd.

(21) Appl. No.: 16/129,998

(22) Filed: Dec. 3, 2018

Related U.S. Application Data
(60) Provisional application No. 62/557,880, filed on Sep. 13, 2017.

(51) Int. Cl. G02B 27/01; G02F 1/167; G02B 26/02

(52) U.S. Cl. CPC G02B 27/0101; G02F 1/167; G02F 2001/1676; G02B 27/0172; G02B 2027/0118; G02B 26/02

(57) ABSTRACT

A display structure with a dimming module and a biasing dimming module and a parallel plate dimming module thereof are revealed. The display structure includes a visual projection display module provided with an ambient-light-contact end and a dimming module disposed between the ambient-light-contact end and ambient light. Thus the ambient light transmitted through the visual projection display module and used as backlight is controlled effectively by the display structure for providing the best vision.

### BACKGROUND OF THE INVENTION

### 1. Technical Field

The present invention relates to a display structure with a dimming module, a biasing dimming module and a parallel plate dimming module thereof, especially to a display structure with a dimming module, a biasing dimming module and a parallel plate dimming module thereof used for tuning transmittance of ambient light.

### 2. Description of Related Art

Displays are widely used in various applications ranging from small screens of televisions, computers and cellular phones to large screens of outdoor signboards, indoor space and vehicles. Getting and using information through the display has become a part of our daily lives. Owing to well-constructed network and applications of displays, users can retrieve information they need from displays in different forms and having various uses through connection between the displays and the cloud. Then various applications and services are further derived.

The display applications have become more widespread, not only indoors but also outdoors and under various ambient light conditions. Now head-mounted displays have been used in games and virtual reality. Automotive head-up displays are also extremely popular. However, without better backlight control, the displays can't provide better images while being used in different environments.

### SUMMARY OF THE INVENTION

Therefore it is a primary object of the present invention to provide a display structure with a dimming module, a biasing dimming module and a parallel plate dimming module thereof that solve the problem of poor imaging caused by varying ambient light levels used as display backlight.

This present invention provide a display structure with a dimming module comprising: a display module provided with an ambient-light-contact end and a dimming module disposed between the ambient-light-contact end and ambient light.

This present invention further provide a biasing dimming module comprising: a transparent package; a sliding medium filled in the transparent package; a plurality of polar light-blocking units that is mounted in the sliding medium and the polar light-blocking unit has not only a curved surface but also a light blocking part and a light transmitting part therein; either the light blocking part or the light transmitting part is having a positive charge or a negative charge; the two adjacent polar light-blocking units are in contact with each other by the curved surface thereof; and a plurality of electrode layers which is disposed on lateral sides of the respective polar light-blocking unit respectively.

This present invention further provide a parallel plate dimming module comprising: a first light transmitting plate provided with a plurality of first rotation axes; a second light transmitting plate that is arranged with a plurality of second rotation axes; and a plurality of parallel plates that is connected to and located between the first rotation axes and the second rotation axes respectively.

Implementation of the present invention at least produces the following advantageous effects:

1. The intensity of ambient light on the display can be adjusted quickly and effectively.
2. The imaging quality of the display is significantly improved.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1A shows an embodiment of a dimming module being connected to a head-mounted display according to the present invention;

FIG. 1B shows an embodiment of a dimming module being connected to a head-mounted display according to the present invention;

FIG. 2 is a schematic drawing showing an embodiment of a dimming module being connected to a head-up display according to the present invention;

FIG. 3 is a schematic drawing showing an embodiment of a dimming module in which a plurality of balls connected to transparent electrodes according to the present invention;

FIG. 4A is a schematic drawing showing operation of balls with charge/magnetic field on two sides in an embodiment according to the present invention;

FIG. 4B is a schematic drawing showing operation of balls with charge/magnetic field on one side in an embodiment according to the present invention;

FIG. 5A is a schematic drawing showing an embodiment of a biasing dimming module with spherical polar light-blocking units according to the present invention;

FIG. 5B is an embodiment of a biasing dimming module with cylindrical polar light-blocking units according to the present invention;

FIG. 6A is an embodiment of a three-electrode dimming module in a driving state for light-blocking according to the present invention;

FIG. 6B is an embodiment of a three-electrode dimming module in a driving state for light-transmitting according to the present invention;

FIG. 7A is an embodiment of a double-electrode-layer dimming module in a driving state for light-blocking according to the present invention;

FIG. 7B is an embodiment of a double-electrode-layer dimming module in a driving state for light-transmitting according to the present invention;

FIG. 8A is an embodiment of a double-electrode-layer dimming module with cylindrical polar light-blocking units in a light-blocking state according to the present invention;

FIG. 8B is an embodiment of a double-electrode-layer dimming module with cylindrical polar light-blocking units in a light-transmitting state according to the present invention;

FIG. 9 is another embodiment of a double-electrode-layer dimming module according to the present invention;

FIG. 10A is an embodiment of a parallel plate dimming module in a light-blocking state according to the present invention; and

FIG. 10B is an embodiment of a parallel plate dimming module in a light-transmitting state according to the present invention.

### DETAILED DESCRIPTION OF THE INVENTION

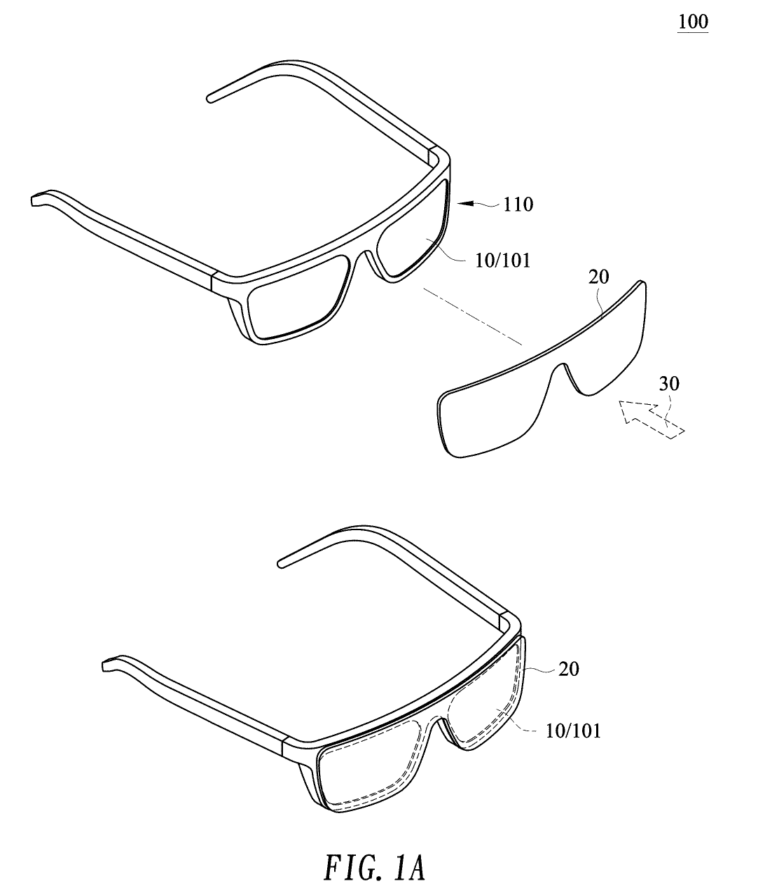

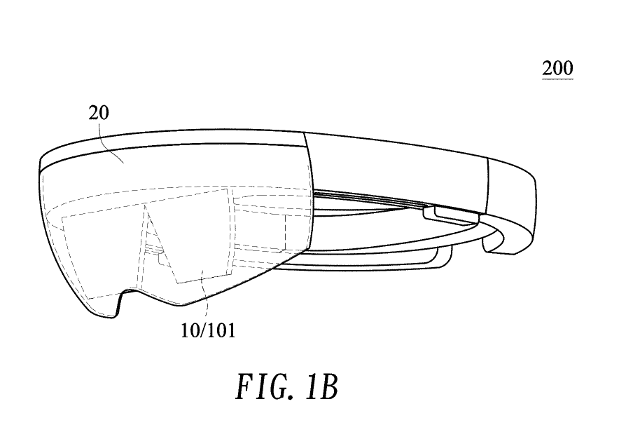

Referring to FIG. 1A, FIG. 1B and FIG. 2, a display structure with a dimming module 100 according to the present invention includes a display module 10 which is a visual projection display module and a dimming module 20. The display module 10 has an ambient-light-contact end 110 and the dimming module 20 is disposed between the ambient-light-contact end 110 and ambient light 30.

The visual projection display module 10 can be a head-mounted display 200, a head-up display 300 or others like a see-through display.

The dimming module 20 is used to control luminous flux of the ambient light 30 entering the display module 10 and used as backlight. Thus the most stable and optimized images on the display module 10 are obtained by means of the dimming module, without being affected by the ambient light 30 when users are in environments with different light intensities.

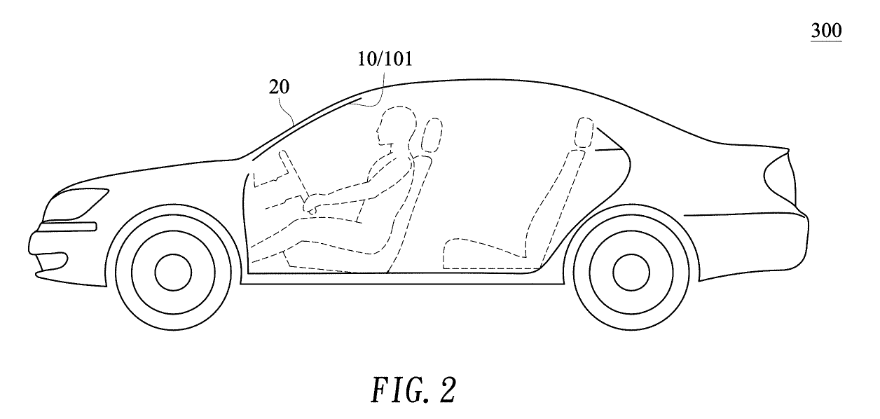

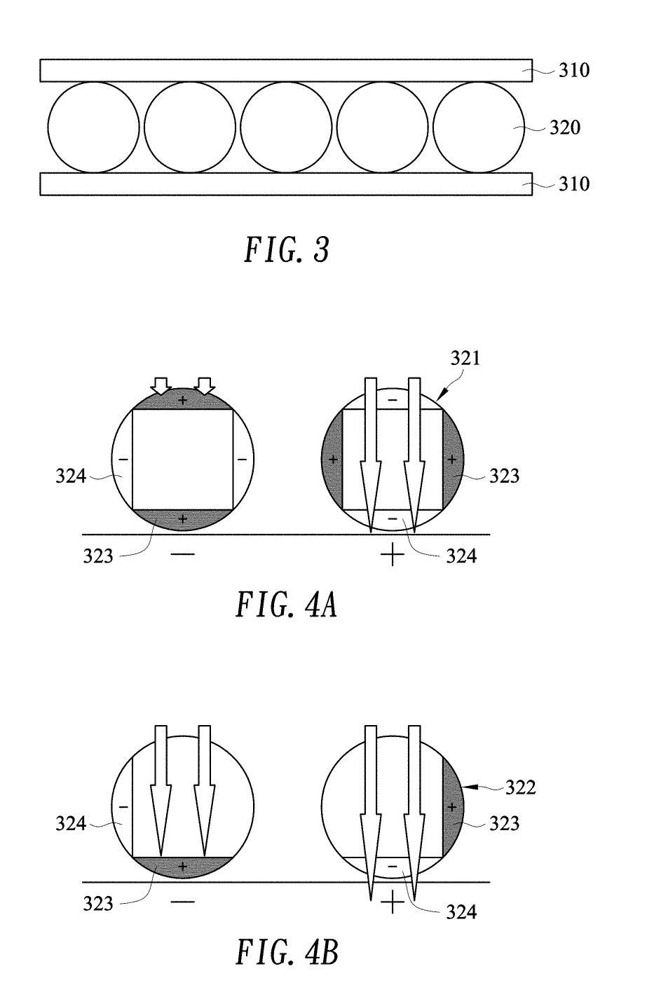

Referring to FIG. 3, FIG. 4A and FIG. 4B, the operation principle of the dimming module 20 is based on two pieces of transparent electrodes 310 between which electrodes or coils are arranged for forming electric/magnetic field and a plurality of balls 320 with charges/magnetic field held between the transparent electrodes 310. There are two kinds of balls 320. One is A TYPE ball 321 that has charge/magnetic field on two sides. The other is B TYPE ball 322 that has charge/magnetic field on one side.

In the above figures, an opaque black part 323 is having a positive charge while a transparent part 324 is having a negative charge. Or the opaque black part 323 is set to have a negative charge while the transparent part 324 is having a positive charge. The positive charge and the negative charge are provided by electrophoretic materials.

The edge of the ball is formed by at least one opaque black positive electrode and at least one transparent negative electrode, or by at least one opaque black negative electrode and at least one transparent positive electrode. The changes in the electric/magnetic field of the transparent electrodes 310 rotate the balls 90 degrees to regulate light transmittance of the dimming module 20.

As shown in FIG. 4A and FIG. 4B, the above A TYPE ball 321 includes two opaque black parts 323 and two transparent parts 324 while the B TYPE ball 322 mentioned above includes one opaque black part 323 and one transparent part 324.

The positive charge and the negative charge on the ball can be replaced by the magnetic field. That means the positive charge and negative charge are changed into N pole and S pole. The rotation of the ball is controlled by the magnetic field generated by a current of the transparent electrodes 310. Thus the transmittance of light through the dimming module 20 is adjusted.

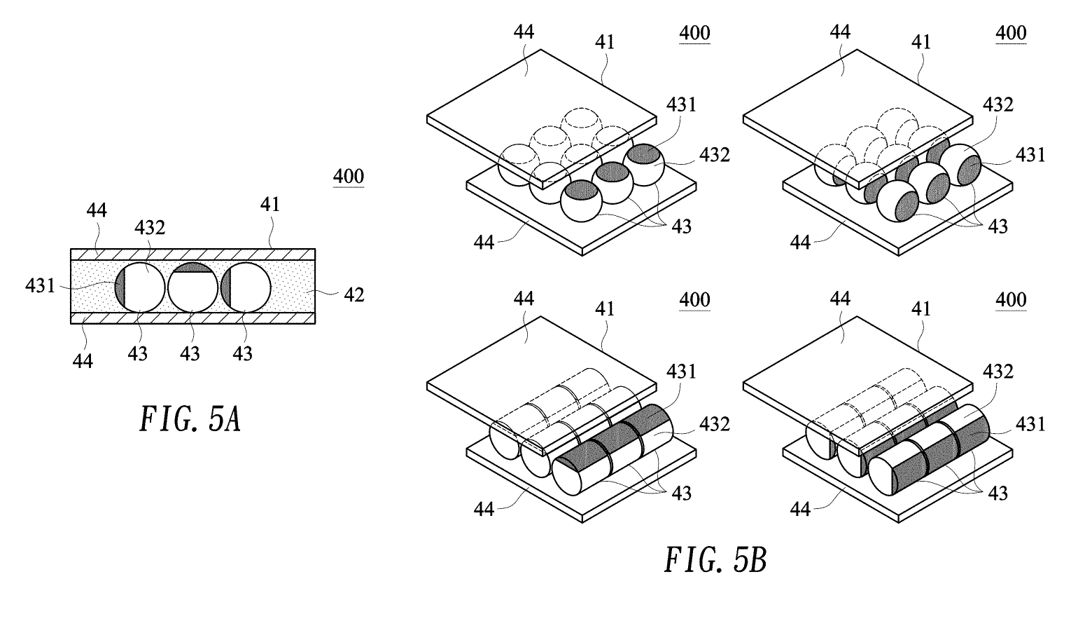

As shown in FIG. 5A and FIG. 5B, the dimming module 20 can also be a biasing dimming module 400 that consist of a transparent package 41, a sliding medium 42, a plurality of polar light-blocking units 43 and a plurality of electrode layers 44. The so-called biasing dimming is defined as arrangement of the positive and negative electrode layers 44 makes the polar light-blocking units 43 with charge/polarity rotate so as to provide a dimming function.

The transparent package 41 is a transparent hollow sealed body. It's in a sealed structure and a mounting space is formed in the sealed body.

The sliding medium 42 is filled into the transparent package 41. That means the sliding medium 42 is filled in the mounting space. For example, the sliding medium 42 can be silicone oil, other liquid or fluid. The used of silicone oil can not only reduce friction between the polar light-blocking units 43 but also make the refractive index of the sliding medium 42 become close to that of the transparent package 41. Moreover, the silicone oil has a larger viscosity coefficient. Thus the polar light-blocking unit 43 can be in a stable state after rotating to different state.

The polar light-blocking units 43 are arranged in the sliding medium 42 and mainly used to provide the dimming function. The polar light-blocking unit 43 can be either a sphere or a cylinder having a curved surface. The two adjacent polar light-blocking units 43 are in contact with each other by the curved surface thereof. Thereby not only the polar light-blocking unit 43 can rotate easily, the contact surface and the friction between the two adjacent polar light-blocking units 43 are also reduced significantly.

Each of the polar light-blocking unit 43 includes a light blocking part 431 and a light transmitting part 432 therein. The dimming function is achieved by the action of the light blocking part 431 and the light transmitting part 432. The light blocking part 431 can be either formed inside the polar light-blocking unit 43 or formed on surface of the polar light-blocking unit 43 by coating. In order to control the state of the polar light-blocking unit 43 easily, the light blocking part 431/or the light transmitting part 432 is having a positive charge/or a negative charge.

The electrode layers 44 are disposed on lateral sides of each polar light-blocking unit 43 respectively. By applying a positive voltage or a negative voltage to the electrode layers 44, the light blocking part 431/or the light transmitting part 432 with the positive charge/or the negative charge has a bias for blocking light or transmitting light.

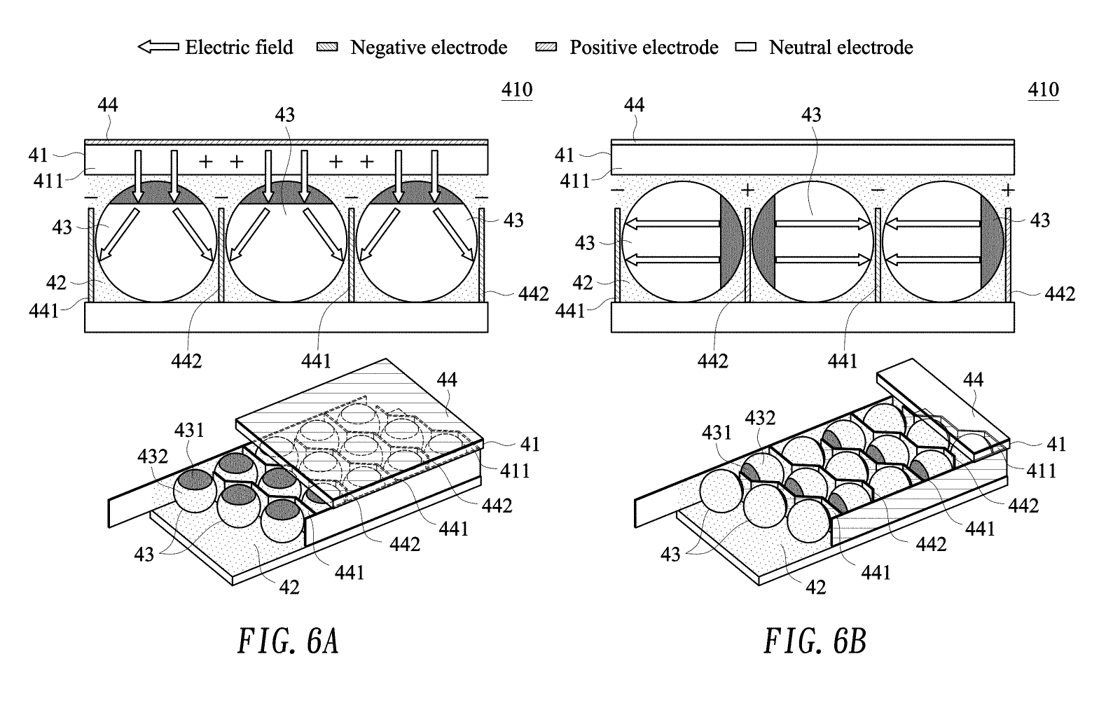

Referring to FIG. 6A and FIG. 6B, a structure of a three-electrode dimming module 410 is revealed. In order to drive the polar light-blocking unit 43 effectively, the biasing dimming module 400 is designed into a three-electrode dimming module 410 in which each of the polar light-blocking units 43 is designed into a sphere or a cylinder.

Moreover, a first bias layer 411 that is an indium tin oxide (ITO) electrode layer is provided. The first bias layer 411 is integrated by a plurality of electrodes with a part of the transparent package 41. A plurality of electrodes is divided into first vertical electrodes 441 and second vertical electrodes 442 that are paired and arranged at two sides of the polar light-blocking units 43 respectively and alternately. The first vertical electrodes 441 and the second vertical electrodes 442 are perpendicular to the first bias layer 411.

While using the three-electrode dimming module 410 for blocking light, the light blocking part 431 of the polar light-blocking unit 43 is having a negative charge. A positive voltage is provided to the first bias layer 411 while a negative voltage is applied to the first vertical electrode 441 and the second vertical electrode 442. Thus the three-electrode dimming module 410 provides the light blocking effect.

In order to make light pass through the three-electrode dimming module 410, the light blocking parts 431 of the polar light-blocking unit 43 are still having a negative charge. But at this time, no voltage is applied to the first bias layer 411, a negative voltage is provided to the first vertical electrodes 441, and a positive voltage is applied to the second vertical electrodes 442. Thereby the three-electrode dimming module 410 allows light to transmit.

For best light blocking effect, two three-electrode dimming modules 410 are stacked to form a structure having upper and lower layers connected to each other. Or a plurality of three-electrode dimming modules 410 is stacked to form a structure having a plurality of layers connected to one another. The polar light-blocking units 43 of each layer of the three-electrode dimming module 410 are staggered for improving light blocking effect.

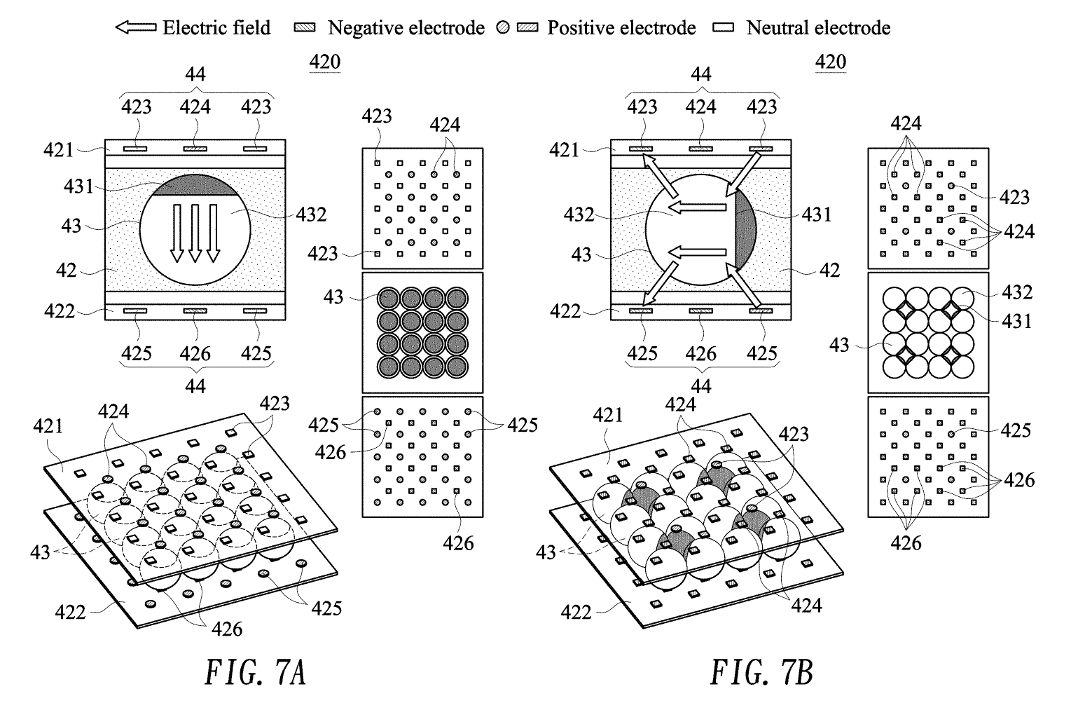

Referring to FIG. 7A and FIG. 7B, besides the above three-electrode dimming module 410, the biasing dimming module 400 can also be designed into a double-electrode-layer dimming module 420 which includes a first electrode layer 421 and a second electrode layer 422.

The first electrode layer 421 is an indium tin oxide (ITO) electrode layer that includes a plurality of electrodes spaced in a part of the transparent package 41. More specifically, the first electrode layer 421 includes a plurality of first electrodes 423 and a plurality of second electrodes 424. The first electrodes 423 are equidistantly spaced in a 2-dimensional (2D) array. Thus a square array is provided. As to the second electrode 424, it is disposed on the center of the adjacent four first electrodes 423.

The second electrode layer 422 is also an indium tin oxide (ITO) electrode layer formed by a plurality of electrodes spaced in another part of the transparent package 41 and corresponding to the first electrode layer 421. More specifically, the second electrode layer 422 includes a plurality of third electrodes 425 and a plurality of fourth electrodes 426. The third electrodes 425 are equidistantly spaced in a 2-dimensional (2D) array. Thus a square array is provided. As to the fourth electrode 426, it is disposed on the center of the adjacent four third electrodes 425.

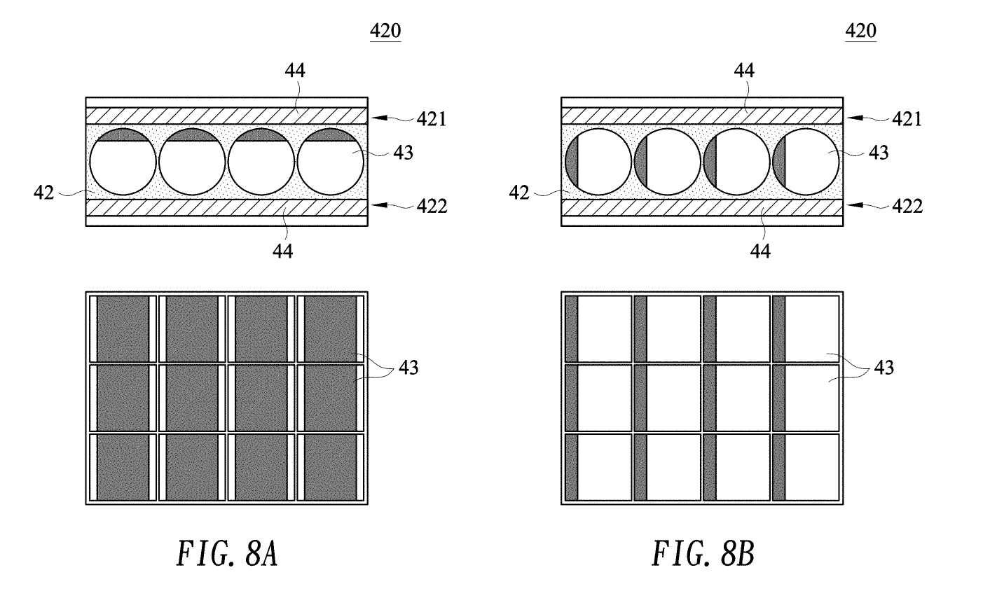

Lastly, a plurality of polar light-blocking units 43 is arranged between the first electrode layer 421 and the second electrode layer 422. During arrangement, the center of each polar light-blocking unit 43 is corresponding to one of the second electrodes 424 and one of the fourth electrodes 426. The polar light-blocking unit 43 can be a sphere or a cylinder (as shown in FIG. 8A and FIG. 8B).

When the double-electrode-layer dimming module 420 is used for blocking light, the light blocking part 431 of the polar light-blocking unit 43 is negatively charged. No voltage is applied to the first electrode 423 and the third electrode 425 while a positive voltage is applied to the second electrode 424 and a negative voltage is applied to the fourth electrode 426. Thereby the double-electrode-layer dimming module 420 provides the shading effect now.

For transmittance of light through the double-electrode-layer dimming module 420, the light blocking part 431 of the polar light-blocking unit 43 is still negatively charged. At the moment, the adjacent four second electrodes 424 and the corresponding adjacent four fourth electrodes 426 form a group respectively. Then a positive voltage is applied to the first electrode 423 and the third electrode 425 at the center of the respective group mentioned above while a negative voltage is applied to the rest first electrodes 423, the rest second electrodes 424, the rest third electrodes 425 and the rest fourth electrodes 426. Thereby the double-electrode-layer dimming module 420 allows the light to pass through.

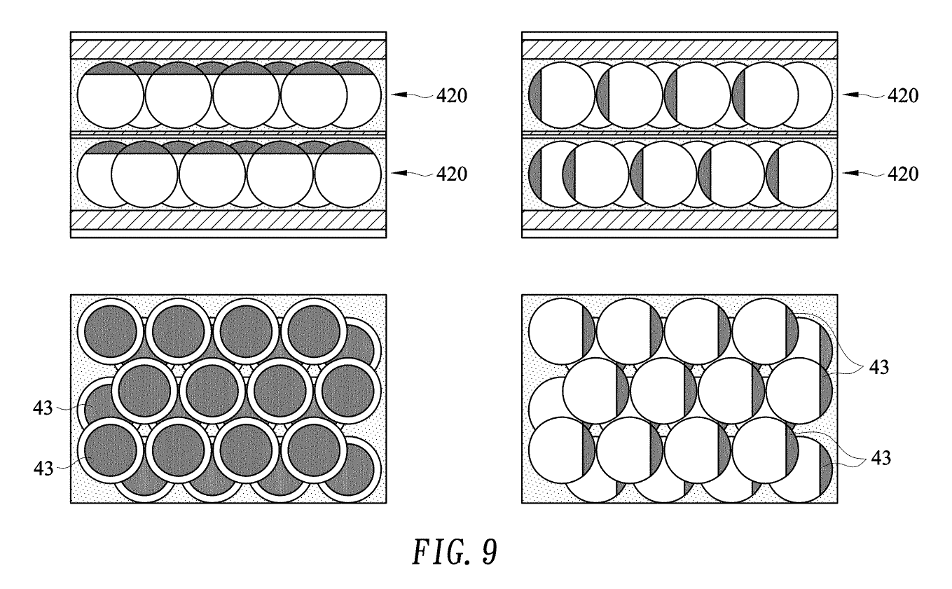

As shown in FIG. 9, for the best light blocking effect, the double-electrode-layer dimming module 420 can be stacked to form a three-electrode-layer or multiple-electrode-layer dimming module in which the electrode layers are arranged in parallel. The polar light-blocking units 43 of the respective layer are staggered for improving light blocking effect.

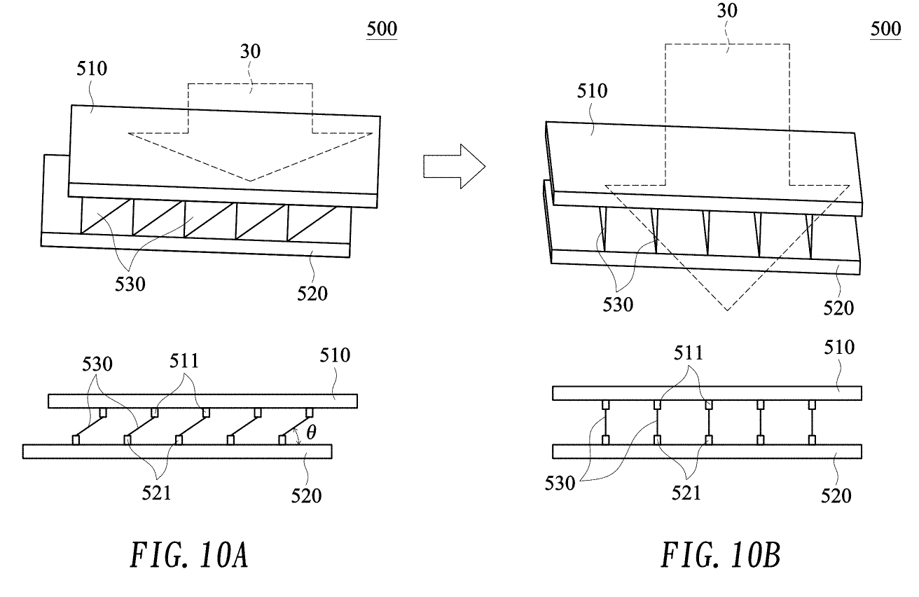

Referring to FIG. 10A and FIG. 10B, a parallel plate dimming module 500 is composed of a first light transmitting plate 510, a second light transmitting plate 520 and a plurality of parallel plates 530. The first light transmitting plate 510 is provided with a plurality of first rotation axes 511 while the second light transmitting plate 520 is arranged with a plurality of second rotation axes 521. The parallel plates 530 are connected to and located between the first rotation axes 511 and the second rotation axes 521 respectively.

The first rotation axis 511 or the second rotation axis 521 can be a transparent rotation axis while the parallel plate 530 is a light reflection plate. The first light transmitting plate 510 and the second light transmitting plate 520 are driven and moved so as to make the parallel plate dimming module 500 have shading effect or allow the light to pass through.

The above description is only the preferred embodiments of the present invention, and is not intended to limit the present invention in any form. Although the invention has been disclosed as above in the preferred embodiments, they are not intended to limit the invention. A person skilled in the relevant art will recognize that equivalent embodiment modified and varied as equivalent changes disclosed above can be used without parting from the scope of the technical solution of the present invention. All the simple modification, equivalent changes and modifications of the above embodiments according to the material contents of the invention shall be within the scope of the technical solution of the present invention.

What is claimed is:

1. A display structure with a dimming module comprising:
a display module provided with an ambient-light-contact end; and
a dimming module disposed between the ambient-light-contact end and ambient light.

2. The display structure as claimed in claim 1, wherein the display module is a head-mounted display or a head-up display.

3. The display structure as claimed in claim 1, wherein the dimming module is a biasing dimming module or a parallel plate dimming module.

4. A biasing dimming module comprising:
a transparent package;
a sliding medium filled in the transparent package;
a plurality of polar light-blocking units that is mounted in the sliding medium and the polar light-blocking unit has not only a curved surface but also a light blocking part and a light transmitting part therein; either the light blocking part or the light transmitting part is having a positive charge or a negative charge; the two adjacent polar light-blocking units are in contact with each other by the curved surface thereof; and
a plurality of electrode layers that is disposed on lateral sides of each of the polar light-blocking units respectively.

5. The biasing dimming module as claimed in claim 4, wherein the polar light-blocking unit is a sphere or a cylinder while a contact surface between the light blocking part and the light transmitting part is a flat surface.

6. The biasing dimming module as claimed in claim 4, wherein the sliding medium is silicone oil.

7. The biasing dimming module as claimed in claim 4, wherein the biasing dimming module is a three-electrode dimming module in which each of the polar light-blocking units is a sphere or a cylinder;
a first bias layer is integrated by at least one electrode with a part of the transparent package; and
a plurality of electrodes is divided into first vertical electrodes and second vertical electrodes that are paired and arranged at two sides of the polar light-blocking units respectively and alternately; the first vertical electrodes and the second vertical electrodes are perpendicular to the first electrode layer.

8. The biasing dimming module as claimed in claim 4, wherein the biasing dimming module is a double-electrode-layer dimming module that includes:
a first electrode layer that includes a plurality of electrodes spaced in a part of the transparent package;
a second electrode layer that is formed by a plurality of electrodes spaced in another part of the transparent package and corresponding to the first electrode layer; and
the plurality of polar light-blocking units is disposed between the first electrode layer and the second electrode layer while each of the polar light-blocking units is a sphere or a cylinder.

9. The biasing dimming module as claimed in claim 8, wherein the first electrode layer includes:
a plurality of first electrodes that is equidistantly spaced in a 2-dimensional (2D) array; and
a plurality of second electrodes each of which is arranged at the center of the adjacent four first electrodes;
the first electrode layer includes:
a plurality of third electrodes that is uniformly spaced in a 2-dimensional (2D) array;
a plurality of fourth electrodes each of which is arranged at the center of the adjacent four third electrodes;
wherein the center of each of the polar light-blocking units is corresponding to one of the second electrodes and one of the fourth electrodes.

10. A parallel plate dimming module comprising:
a first light transmitting plate provided with a plurality of first rotation axes;
a second light transmitting plate that is arranged with a plurality of second rotation axes; and
a plurality of parallel plates that is connected to and located between the first rotation axes and the second rotation axes respectively.

11. The parallel plate dimming module as claimed in claim 10, wherein the first rotation axis or the second rotation axis is a transparent rotation axis.

12. The parallel plate dimming module as claimed in claim 10, wherein the parallel plate is a light reflection plate.
